(19) United States
(12) Patent Application Publication
(10) Pub. No.: US 2013/0238347 A1
(43) Pub. Date: Sep. 12, 2013

(54) Systems and Methods for Secure (HIPAA Compliant) Communication of Healthcare and Private Information

(71) Applicant: Marcia Marye DENTON, Kerrville, TX (US)

(72) Inventor: Marcia Marye DENTON, Kerrville, TX (US)

(21) Appl. No.: 13/601,912

(22) Filed: Aug. 31, 2012

Related U.S. Application Data
(60) Provisional application No. 61/529,775, filed on Aug. 31, 2011.

(51) Int. Cl. G06Q 10/06; G06Q 50/22

(52) U.S. Cl. CPC G06Q 10/06; G06Q 50/22
USPC 705/2

(57) ABSTRACT

Systems and methods for allowing communications basics, such as personal email and various application accounts, as well as assisted use of the technologies and a method for safely, and with HIPAA compliance, sharing such communications. Access templates are created, assigned, and registered for each of the participants in the system acting as information sources, information receivers, or both. The systems and methods allow the elderly, disabled, or ill individuals to have access to their family and friends through phone contact, mail contact, email, video mail, and video chat, as well as other communication methods. The sharing of information through current and future communications technologies is made possible without the individual needing to possess the technology or know how to use it specifically. Families are able to share their lives and events in a much more personally connected way and the elderly, disabled, or ill patient can do the same.

### CROSS REFERENCES TO RELATED APPLICATIONS

This application claims the benefit under Title 35 United States Code §119(e) of U.S. Provisional Application 61/529,775 filed Aug. 31, 2011, the full disclosure of which is incorporated herein by reference.

### BACKGROUND OF THE INVENTION

1. Field of the Invention

The present invention relates generally to electronic data communication devices, systems, and networks. The present invention relates more specifically to a secure information communication system and method for use by individuals who, for medical or other reasons, are no longer able to fully utilize such technologies themselves to communicate with family, friends, and other important individuals in their lives.

2. Description of the Related Art

As individuals age and/or become ill or disabled, it is not uncommon for these individuals to lose their capacity to use common everyday technologies to communicate. As individuals lose cognitive function, they may not even be able to answer the phone if, for example, it requires the choice of a button to push or the like, much less be able to use a computer to send or receive emails or other messages and files. For such individuals, it is typically impossible to make the transition to the use of smart phones or computer tablets to receive video calls or emails from family and friends.

Many families are no longer together in the same geographic location making the family's disconnection with an ill or disabled individual even more pronounced and difficult. It is not unusual for the elderly, ill, or disabled, requiring medical attention to be provided information from medical staff and to find it difficult to communicate or translate the same to the rest of the family. Such efforts as translating medical information are often incomplete or inaccurate making the need for clear, direct, and accurate communication between doctors, staff, facilities, and the families of the patients even more important.

Although current technology does allow for communication between individuals through a number of devices and over a number of local and wide area networks, there is currently no specific system available that provides the service to someone that is elderly, disabled, or otherwise incapacitated. This failure is in part related to the requirements associated with security and privacy that derive from the transmission of sensitive healthcare information that is subject to HIPAA. Whatever service and method developed to address the communication concerns of the elderly, disabled, or ill, it must comply with the legal requirements for communication information associated with that individual's health and privacy. The methods required, therefore, should fulfill the need not just for communication, but for the infrastructure and mechanisms for such communication to be accomplished by individuals who are otherwise unable to take advantage of the technology due to limited cognitive or physical capacity.

### SUMMARY OF THE INVENTION

The present invention provides a procedure (systems and methods) for allowing for the communication basics, such as personal email and various application accounts, as well as assisted use of the technologies and a method for safely, and with HIPAA compliance, sharing such communications. The systems and methods of the present invention allow the elderly, disabled, or ill individuals to have access to their family and friends through phone contact, mail contact, email, video mail, and video chat, as well as other communication methods as they develop. The sharing of information through current and future communication technologies make this possible without the individual needing to possess the technology or know how to use it specifically. Families are able to share their lives and events in a much more personally connected way. With the present invention, the individual elderly, disabled, or ill patient can do the same. This type of mutual exchange has been shown in the past to boost the quality of life for all individuals involved. Isolation and miscommunication is destructive to the quality of life, can lead to the exacerbation of illness as opposed to supporting a positive environment which has been shown to improve immunity as well as mood.

Doctors, facilities, and care staff are able, through the systems and methods of the present invention, to provide accurate, clear, and concise information necessary to make good, informed decisions about the care of a family's loved one. The benefits to the providers are twofold; a positive working relationship with the patient in a manner that allows the provision of optimum care and direct and clear communication through the relationship. This may all be accomplished without having to re-state or otherwise clarify the information given to families by patients and clients where time and stress may be involved.

### BRIEF DESCRIPTION OF THE DRAWINGS

FIG. 1 is a schematic block diagram showing the participant entities in the system of the present invention.

FIG. 2 is a functional relationship schematic block diagram showing the representative electronic data communication devices and data storage network devices of the system of the present invention.

FIG. 3 is a top level flowchart of the process of the present invention for establishing and registering the HIPAA compliant operation of the system.

FIG. 4 is a Venn diagram of the types of information that are handled by the systems and methods of the present invention and of the various groups that are permitted access to the information.

FIG. 5 is a schematic diagram characterizing the structure of a database that includes the various types of information stored and communicated through the systems and methods of the present invention.

FIG. 6 is a detailed flowchart of the process for template registration in the operation of the system of the present invention.

FIG. 7 is a schematic block diagram outlining the database and data communication structures within a single electronic data communications device used at a single location within the system of the present invention.

FIG. 8 is a schematic diagram showing (as an example) a split key data matrix two dimensional code for device access security implemented within the system and methods of the present invention.

### DETAILED DESCRIPTION OF THE PREFERRED EMBODIMENTS

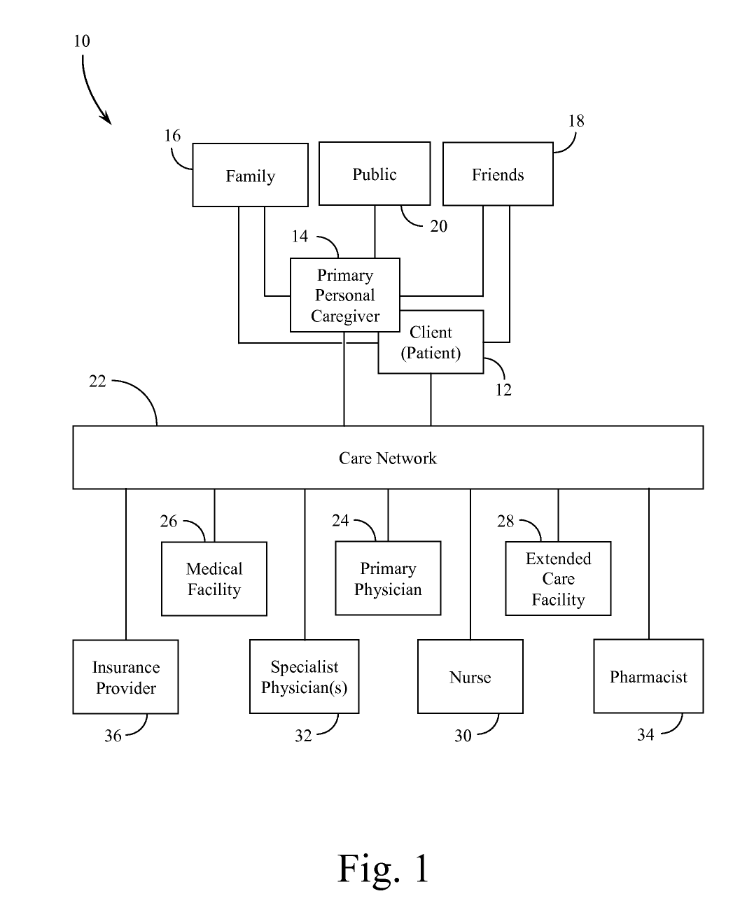

Reference is made first to FIG. 1 for a description of the various entities that are participant in the systems and methods of the present invention. FIG. 1 is a schematic block diagram showing the various entities and the manner of their alignment with regard to the overall care network associated with an individual referred to in this example as the patient. Those skilled in the art will recognize that the systems and methods of the present invention are applicable to individuals beyond those that might be identified as healthcare patients. Many individuals suffer the same cognitive deficiencies and physical disabilities that prevent them from fully utilizing modern technologies associated with communication. The various entities described and shown in FIG. 1 are representative of those that might be associated with a healthcare patient, although alternate entities and system participants would be similarly identified with other types of individuals requiring use of the system.

FIG. 1 in general shows a communication network participant array 10. Central to this array of participants is client (patient) 12. Closely associated with client 12 is preferably a primary personal caregiver 14. It is understood that in some circumstances there might not be a primary personal caregiver 14 and that the client themselves might act as the functional equivalent of these two identified participants. Associated with client 12 and primary personal caregiver 14 are family 16, friends 18, and the wider public 20. The connections between these various participants are shown in FIG. 1 wherein client 12 may have some connection with friends 18 and family 16, but most likely no direct connection with public 20. Primary personal caregiver 14 on the other hand may have functional connections to not only family 16 and friends 18 but also to public 20. Primary personal caregiver 14 therefore provides something of a buffer between client 12 and public 20.

Client 12 and primary personal caregiver 14 are connected to what may generally be described as care network 22. Care network 22 may be seen as made up of a large number of external individuals and entities that provide services and information to client 12. As a medical patient (in this example) the participants in care network 22 might include primary physician 24 as well as a medical facility 26, and/or an extended care facility 28. In addition to these primary care participants, an insurance provider 36 may require connection to care network 22 as will additional specialist physicians 32, nurses 30, and pharmacists 34. In summary, FIG. 1 is intended to show, not only the various participants that the systems and methods of the present invention intend to include in the communications effort, but also the manner in which these various participants service and communicate with the central participant in the system, namely, the client/patient.

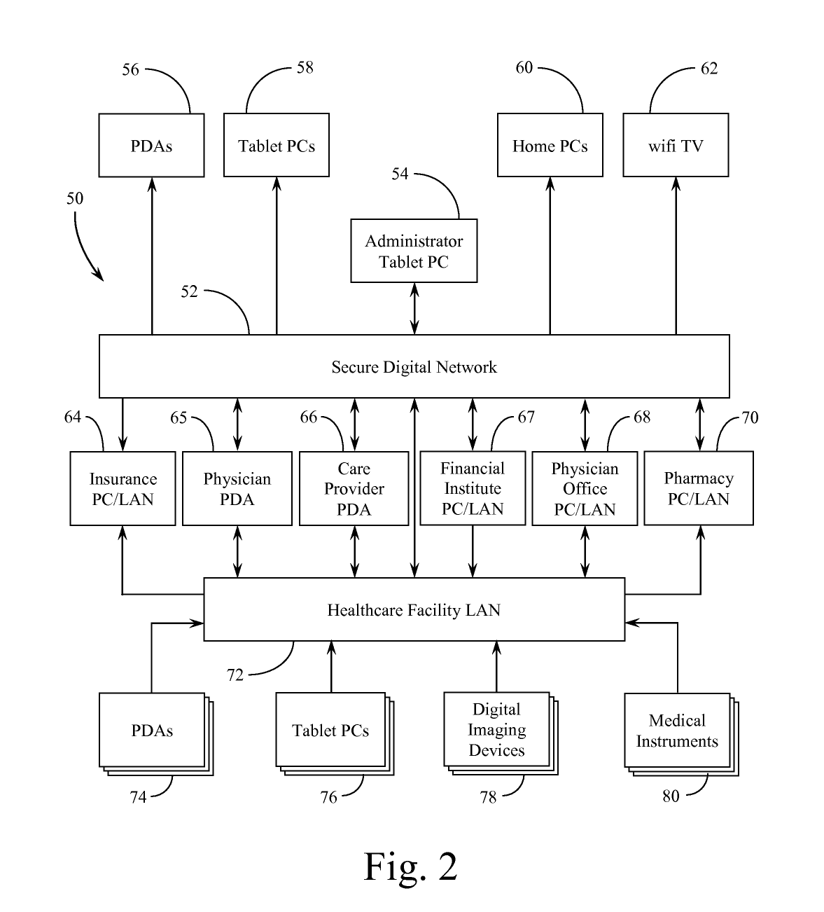

FIG. 2 provides additional detail regarding the functional relationships between the various entities participating in the system, set forth with specific reference to the type of electronic communications devices and data storage/networking devices that the participants may most likely have access to. Data communications devices and networks 50 includes a complex array of various electronic data processing devices, communication devices, and data storage networking devices that allow for one or two way communication of information and data within the system. On the top end of secure digital network 52 shown in FIG. 2 are positioned the various receivers of information that include a centrally configured administrator tablet PC 54. Such an EDP communications device may be the preferable instrument for the primary personal caregiver and patient (see FIG. 1) to interact with the systems and methods of the present invention. There is therefore a two way communication established between administrator tablet PC 54 and the secure digital network 52.

In addition, any number of PDAs 56, tablet PCs 58, home PCs 60, and wifi TV devices 62, may likewise connect to the secure digital network 52 and may receive information from it according to the protocol of security constraints that have been established and are described in more detail below. FIG. 2 as a relationship functionality diagram shows the flow of information for these various participants using the types of EDP communication devices shown.

Those electronic data processing (EDP) communications devices on the “other side” of secure digital network 52 would themselves center around healthcare facility local area network (LAN) 72. A number of these EDP devices, however, would be in direct communication with secure digital network 52, such as the physician who would have a physician PDA 65 and/or other care provider who would have care provider PDA 66. In addition, the physician's office, by way of physician office PC/LAN 68, would be in communication with secure digital network 52, as would pharmacy PC/LAN 70. Finally, insurance PC/LAN 64 might receive information from secure digital network 52, although it may not typically transmit such information. Conversely, financial institute PC/LAN 67 might provide information and data into healthcare facility LAN 72 but would not likely have access into the LAN.

In addition to the various PCs, PDAs, and LANs that are in direct communication with secure digital network 52, a variety of other electronic data processing devices are in communication with the system of the present invention through healthcare facility LAN 72. These may include a number of PDAs 74 that are accessed by individual care providers within the healthcare facility but which may not directly communicate with the patient, or more specifically, with the administrator tablet PC 54 through secure digital network 52. It should be noted that healthcare facility LAN 72 may communicate directly back and forth with secure digital network 52 or may communicate through the various individual devices described above. In addition to PDAs 74, there may be a variety of tablet PCs 76, digital imaging devices 78, and other electronic data processing instruments 80, all typically associated with the operation of the healthcare facility. These EDP devices within the healthcare facility may be under the control of individuals acting as care providers within the facility, or may be automated devices such as monitors and other systems typically associated with patients within the facility.

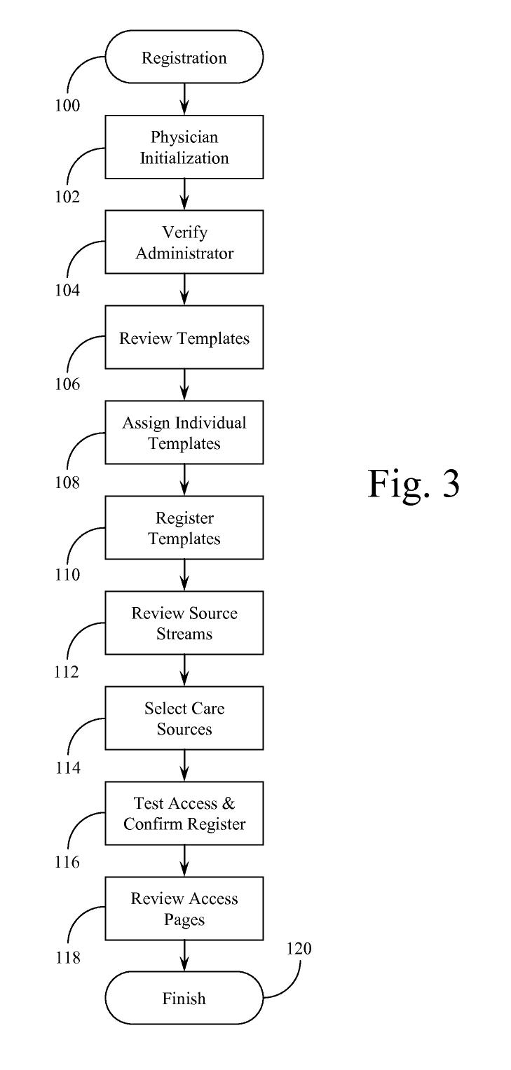

Reference is next made to FIG. 3 for a top level flowchart and a description of the manner in which the systems and methods of the present invention are established and registered for HIPAA compliant operation. The registration process may be initiated at Step 100 which begins with physician authorization at Step 102. Because the primary care physician is the central repository of healthcare information that is subject to the privacy and security concerns of the system, registration of the system and its initial operation must generally occur by providing access through authorization by the primary care physician. This step therefore requires some initial action by the primary care physician within the software operation of the system. Step 104 includes verification of the administrator for the system, which may be, as discussed above, either the patient (client) or a primary personal caregiver, or a combination of the two. Administrator verification will typically occur with a specific electronic data communications device, such as the administrator tablet PC 54 as shown in FIG. 2.

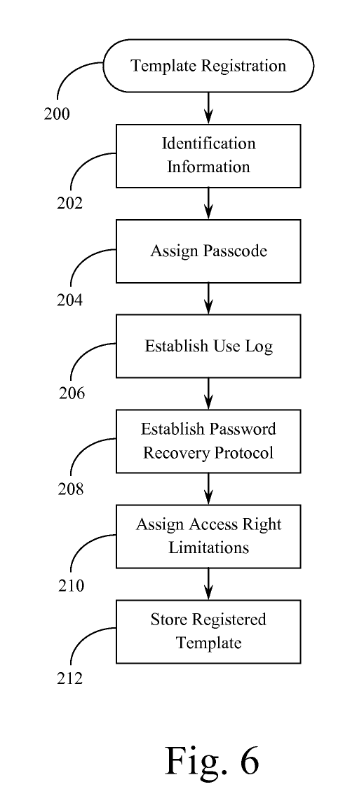

The registration process then proceeds at Step 106 whereby the administrator would review templates that are associated with the access rights authority and security associated with the system. As described in more detail below, various participants within the system are categorized according to established templates that in part define their functional relationship with the patient, and in part define the type of information that they provide to the system, or require from the system. The process then proceeds at Step 108 to assign individual participants (see FIG. 1) various pre-configured templates based upon the catalog of templates established for the system. These templates are then registered at Step 110, a process that is described in more detail in FIG. 6. The administrator then reviews the various information source streams at Step 112 and identifies and selects the relevant care sources at Step 114. The administrator may then test access to both the care sources and to the participants through the registered templates and confirms the complete registration process at Step 116. Finally, the administrator and/or the participants may review the various access pages at Step 118 before completing the overall registration process at Step 120.

The flowchart shown in FIG. 3 is intended to be a very broad stroke description of establishing the overall system of the present invention and carrying out some of the methodology. Once up and running, the system may operate according to a number of different standard communications protocols, although it will be recognized that the template structure of the system provides the core manner of assigning access and source information to the system participants, all of which derives from the initial physician authorization at Step 102.

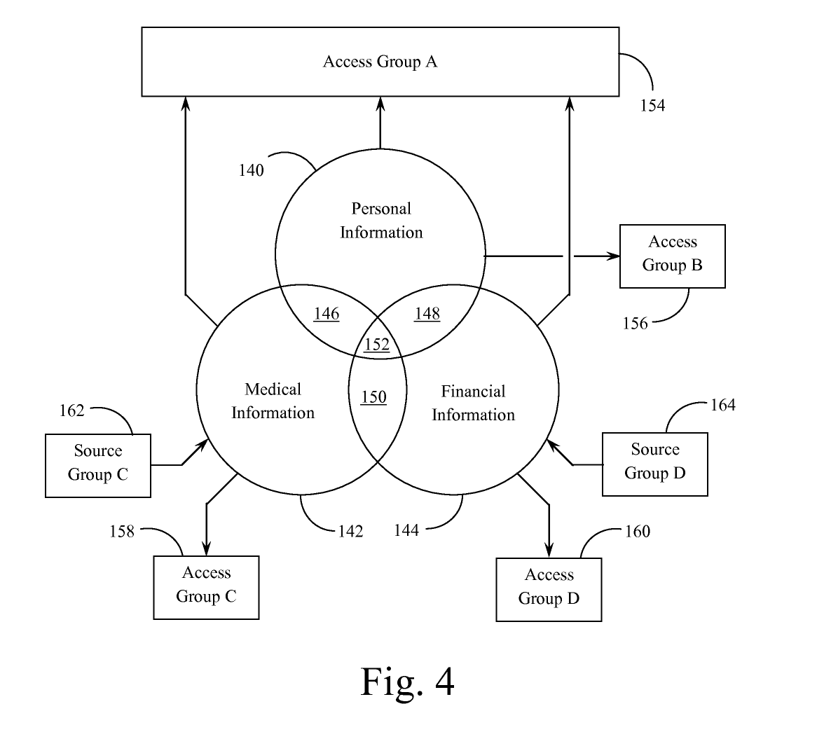

Reference is next made to FIG. 4 which provides a Venn diagram with associated schematic block diagram components that show the types of information that are handled by the systems and methods of the present invention and the various groups that are permitted access to this information. The diagram shown in FIG. 4 provides a basis for defining the various templates that are utilized in the registration process of the systems and methods of the present invention.

Information relevant to the present invention may generally be divided into three categories; these include personal information 140, medical information 142, and financial information 144. As the diagram indicates, there is some overlap between each of these various categories of information. Some personal information that might be categorized as medical information will fall within the personal/medical overlap 146. Likewise, some personal information that might be categorized also as financial information may be found in the personal/financial overlap 148. There may even be some medical information that overlaps with the financial information in medical/financial overlap 150, although such overlap information would typically also involve personal information which would therefore reside in the triple overlap category 152.

As indicated above, the division of data and information into the categories of personal, medical, and financial is primarily made for the purposes of establishing standardized templates by which the systems and methods of the present invention may operate. The corollaries to the types of information stored are the various participants in the system that have access to such information, either as providers of the information or as receivers. FIG. 4 diagrams these information and data relationships as well.

Access Group A 154 is generally characterized as being on the receiving end of information from each of the three areas 140, 142, and 143. This Access Group A 154 may simply be the client/patient and the primary personal caregiver, or may be expanded to include other family members that have reason to access not only personal and medical information, but also financial information. There may also be a significant Access Group B 156 that is only interested in personal information and has no need of the medical or financial information of the client/patient.

Access Group C 158 is that group that need only have access to medical information 142, being unconcerned with financial information or personal information beyond that which overlaps with medical information at overlap 146. In a similar manner, Access Group D 160 may require only financial information and need only have access to personal information that overlaps with financial information at overlap 148.

The source for personal information 140 is, of course, the individual client/patient and is generally derived internally rather than from outside sources. In contrast, medical information 142 and financial information 144 are more closely derived from outside sources that convey information to the individual client/patient or representative. Source Group C 162 may provide the bulk of medical information 142 for the system as a whole, while Source Group D 164 provides the bulk of financial information 144 relevant to the group as a whole.

Once again, the diagram shown in FIG. 4 is intended to establish a base line from which various model or standardized templates may be created. A separate template may, as an example, be created for each of the four Access Groups identified in FIG. 4. A first, very narrow template might identify the client/patient, and their personal caregiver, namely Access Group A 154. A second template might broadly identify Access Group D 160 that requires only financial information 144 and is restricted from receiving medical information 142 that is not present in the medical/financial overlap 150. Source Groups as shown in FIG. 4 would not typically comprise the makeup of any of the templates as the information flow is into the system rather than out. In some cases the Source Group entities are automated facilities that provide medical or financial information not associated with a direct communication from an individual.

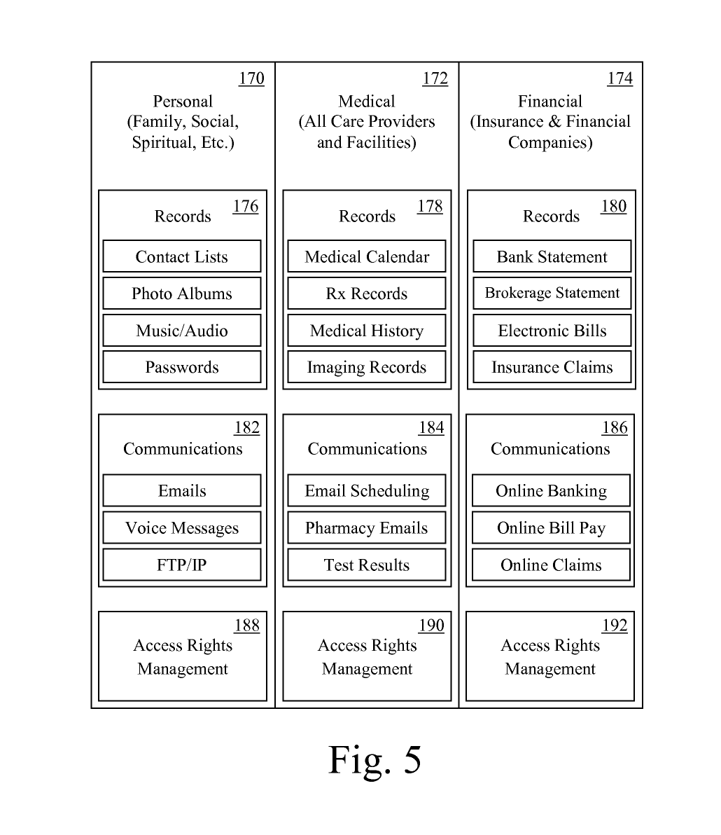

FIG. 5 represents one possible database and data communication structure associated with an electronic data communications device appropriate for use with the systems and methods of the present invention. The database diagram shown is divided into the three basic information categories as described above with respect to FIG. 4. Personal information 170 might generally include family information, social information, spiritual information, and so on. A second category, medical information 172 might involve all data and communications with each of the care providers and healthcare facilities connected to the system. Finally, financial information 174 would include all data and communication with insurance and financial entities such as medical health insurance providers and banking institutions.

Each of the three categories of information might likewise have assigned to it discreet database sections that involve records, communications, and access rights management. For example, personal information 170 may contain a large database section for records 176 that includes personal contact lists, photo albums, music and audio files, as well as personal passwords and the like. In a similar manner, the medical information 172 portion of the database would include records 178 that might comprise medical calendar information, prescription records, medical history, and various imaging record files. Finally, financial information 174 in the database construction would include records 180 that might comprise bank statements, brokerage statements, electronic billing, and insurance claim documents.

In addition to the records storage that would be carried out in conjunction with each of the three types of information, separate communications information and data would be structured within the overall database structure. Communications section 182 within the personal information 170 portion of the database might include personal emails, voice messages, and a file transfer protocol (FTP) setup to handle the transfer of personal files. In a similar manner, medical information 172 would include communications section 184 that might involve email scheduling communications, pharmacy email communications, and the communication of test results and the like. Finally, various communications 186 may be handled within the database parameters associated with financial information 174. In this case, communications would include such things as online banking, online bill pay, and online insurance claims processing.

Each of the various categories and divisions within the database of an individual electronic data communications device would require an access rights management section that, once registered, provides the security control over the flow of data in and out of that section of the database. Access rights management 188 controls personal information 170, access rights management 190 controls medical information 172, and access rights management 192 controls financial information 174.

FIG. 5 therefore provides a detailed breakdown of not only the types of information that may be accessed within the system, but also various mechanisms and records by which the information may be further divided among the system participants. For example, the physician's office may only have need to access medical calendar records and medical history without need for prescription records or pharmacy emails and the like. In contrast, a pharmacy may have only limited need to access medical records and may communicate only such pharmacy emails as are required to provide prescription confirmation.

In a similar manner, further template limitations might be based on divisions within financial information sector 174, wherein online bill payments may be carried out with specific vendors isolated from any access to insurance claim information. Therefore, while the present disclosure does not detail each and every specific template that might be established and registered with the systems and methods of the present invention, it provides the overall framework within which such templates are to be established. As indicated above, clients or individuals outside of the healthcare field that might also benefit from the systems and methods of the present invention would incorporate a different but similar set of templates.

Reference is next made to FIG. 6 which provides additional detail regarding the template registration process identified initially in FIG. 3. The template registration process at Step 200 begins by establishing identification information at Step 202. This identification information, of course, initially involves the primary participants in the system, and then secondarily involves family, friends, and the public that will be given access to some part of the overall data communications. At Step 204 the individual to whom a template is being registered is assigned a passcode. Thereafter, the process establishes a use log at Step 206 which provides a record reviewable by the administrator of the system reflecting the transfer of data and the communications pathways that are open to an individual under the structure of a given template.

It is beneficial at Step 208 to establish a password recovery protocol, as many participants in the system will likely, at least initially, forget or not be made aware of the passcodes and passwords associated with access to the system. Then at Step 210 the template registration assigns access rights limitations, essentially a manner of customizing a template based upon an individual's specific need requirements and limitations. Finally, at Step 212 the registered template is stored and maintained until need for access to the system by that individual is terminated or is altered in some way.

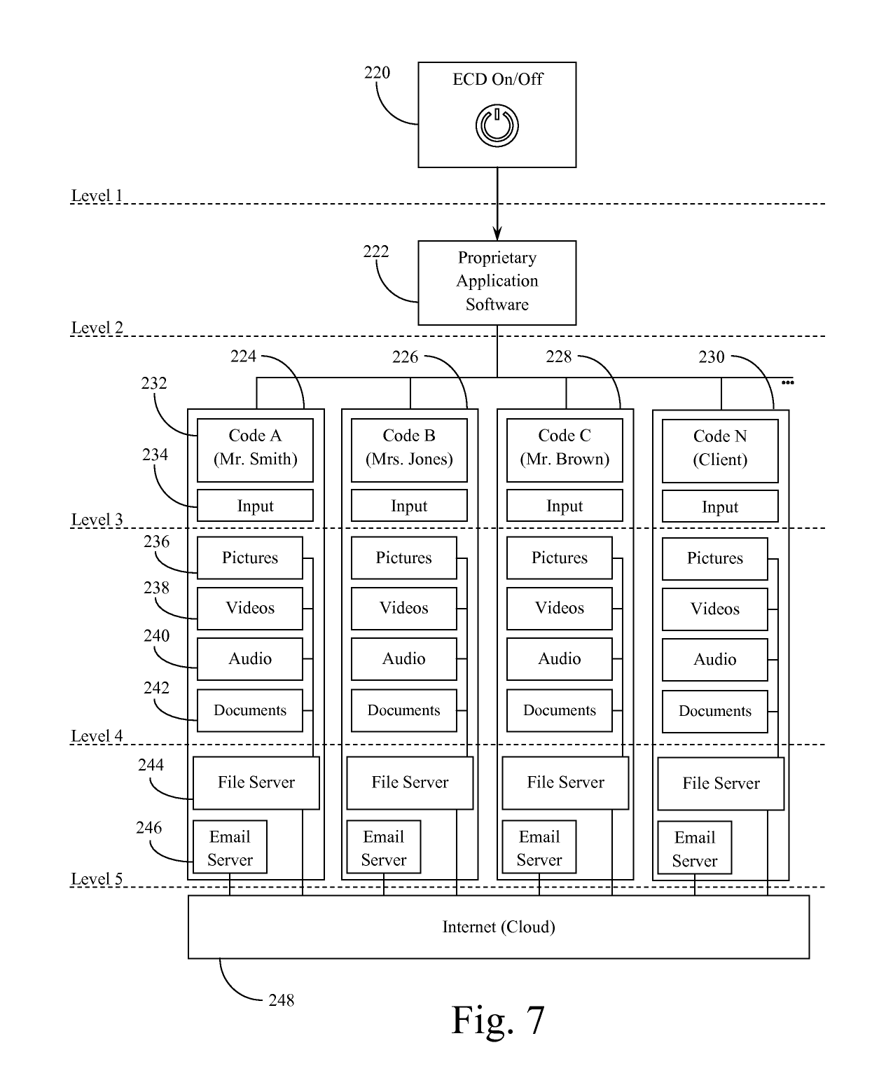

FIG. 7 provides a yet more detailed diagram showing the possible operation of a single electronic communications device (ECD) and the manner in which a single device may be structured to function as an isolated HIPAA compliant communications component. The device set forth in FIG. 7, as an example, may be utilized at a healthcare facility, such as a long term care facility, and may be established for use by any number of individuals within the facility. The critical characterization of the system of the present invention is that when a particular device is established for use by one individual, those components within the device (database components and communications channels) are isolated from similar constructions for other clients/patients.

As an example, FIG. 7 might show the flow of communication where an individual in a nursing home or extended care facility would wish to communicate a photo from themselves within the facility to a family member or friend outside the facility. The single device may be handled by a healthcare service provider within the facility and is initially activated at 220 where the electronic data communication device is switched on. This characterizes the first level (Level 1) of security wherein the retention of the device within a confined healthcare facility provides some measure of security with regard to access and use of the device. A second level of security is established by activating the proprietary application software 222 associated with the present invention. This may itself be password protected, i.e., simply activating the software to establish a data communications device for a particular individual must be preceded by an authorized user input. This second level (Level 2) of security makes sure that only those authorized to carry out this activity with individuals within the facility not only have limited access to the device, but also have limited access to the proprietary software for carrying out the activity (i.e., communications by the client/patient).

A third level (Level 3) involves the identification and distinction of a particular individual for whom the ECD will be configured for use. In FIG. 7 four examples of device configuration (construct) are provided and are designated by separate codes and individual's names. Device construct 224, for example, may be established under Code A for Mr. Smith. Device construct 226 may be established under Code B for Mrs. Jones. Device construct 228 may be established under Code C for Mr. Brown, and device construct 230 may be established under Code N for any additional clients or patients associated with the facility. Each of these device constructs would include a unique access code 232 that initiates the segregation of all database components within the device specific for use by, in this example, Mr. Smith. Input 234 would allow operation of the device in conjunction with various instructions that might be provided to facilitate communications and identify the data and/or files that are to be communicated.

Segregated input 234 shown in FIG. 7 may represent a wide variety of ports, channels, and connected devices that communicate data into the electronic communication device (ECD) shown generally in FIG. 7. In other words, the same software segregation and isolation that is carried out with regard to files, data storage, and the like, within the ECD is likewise carried out with regard to ports, channels, and serial or parallel input connections associated with a particular user (client/patient). These inputs 234 could relate to something as simple as an audio input device that records the spoken word of an individual wishing to communicate information (related to healthcare issues, for example) to an individual or entity that is part of the patient/client's care network. Other more complex devices such as medical instruments and the like may also comprise the input 234 components. These medical instruments may include a wide range of vital sign measuring equipment, such as pulse oximeters, blood pressure monitors, and other types of physiological characteristic monitoring equipment that may be relevant to the patient/client's physical condition. By providing the signal data output of such devices as inputs to the specifically segregated and structured ECD of the present invention, this data and information is subjected to the same security constraints and access limitations that all of the other personal information within the system is subjected to. In other words, the same access constraints can be implemented in conjunction with such medical instrumentation data when it is communicated through the proprietary application software 222 of the system of the present invention as shown, for example, within the structured ECD of FIG. 7.

In addition to integrating medical instrumentation into the ECD of the system shown in FIG. 7, this medical instrumentation may stand on its own in the manner shown in FIG. 2, wherein medical instruments 80 provide signal data to healthcare facility LAN 72 as the manner of communicating the necessary information and data to the overall secure digital network 52, the security of which is being administered by the systems and methods of the present invention. In the configuration shown in FIG. 2 this instrumentation is provided with the necessary security access restrictions by means of the implementation of the systems and methods of the present invention on both the healthcare facility LAN and the administrator tablet PC shown connected through the secure digital network.

The initial access and input shown as access codes 232 and input 234 in FIG. 7 together establish the third level (Level 3) of security. Below this level, actual access to the data and files is maintained within a fourth level (Level 4) of security. At his level, visualization of the data or the files on the device itself may occur. This could include pictures 236, video 238, audio 240 and documents 242. A further security level may be structured where the data and files that are to be communicated outside of the device (to, for example, the Internet 248) are segregated. This security Level 5 communication may be established through a file server component 244 and also through an email server component 246.

As indicated above, the primary objective of the present invention is to allow for HIPAA compliant communications to occur from a single electronic data communications device when it is configured for the same by the proprietary software of the present invention. In other words, the proprietary software constructs a device within a physical piece of hardware that, for all practical purposes (and for security purposes), would appear as a unique electronic data communications device with information and communications channels accessible only to (or on behalf of) a particular individual. By constructing these isolation walls, and maintaining isolation between both the data and communications channels when structured in this way, the present invention provides such systems and methods that are not only easy to use by the participants in the system, but compliant with the security and privacy requirements established by such legal frameworks as HIPAA.

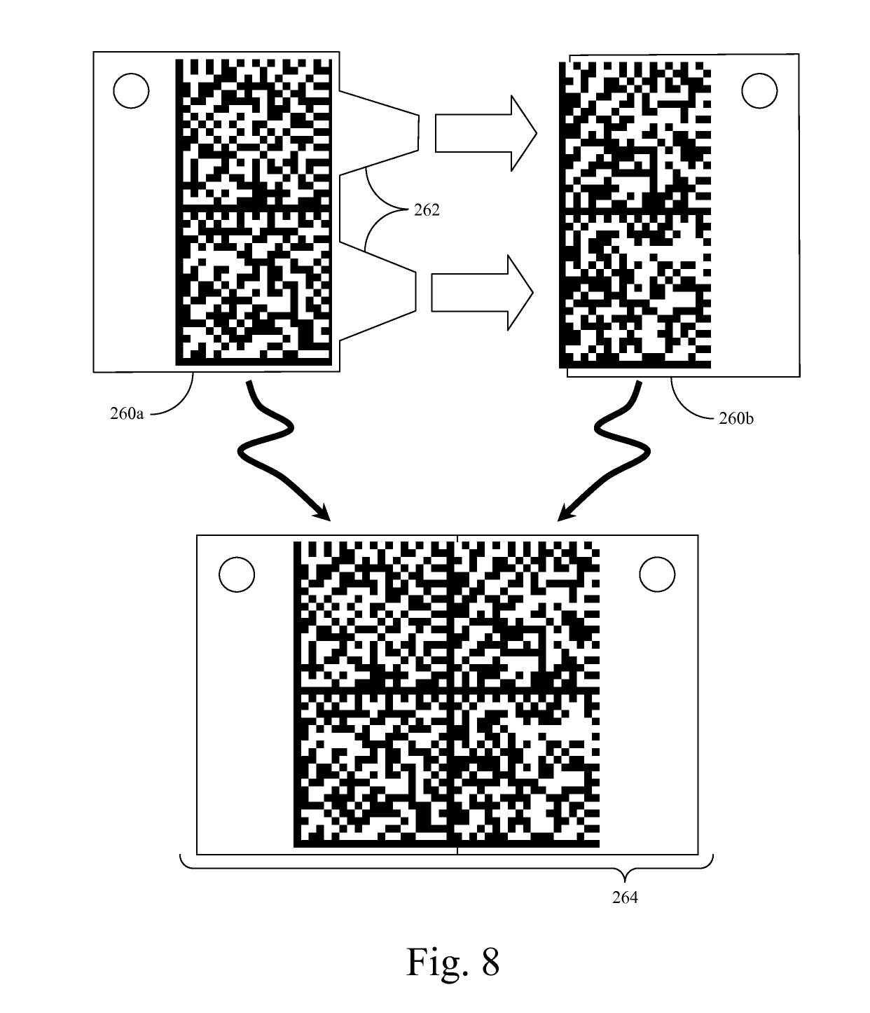

Reference is finally made to FIG. 8 for a description of an example of a split key data matrix 2D code for device access security implemented within the system and methods of the present invention. A data matrix code can provide a link to a folder which has URL (Internet address) links to certain open accounts. Use of this feature means that a password is not needed except to open up the account (by the family) and that once opened the aide will have access only by way of the data matrix display pattern to get to the folder with the links. A matched data matrix opens up folder containing the necessary URLs to open various secure programs like email, drop box, gallery medical data, etc. As such the password is not needed and is unknown to the aide. Access is acquired through the use of a smart device dependent with a camera for imaging the data matrix. The use of such an access key allows for isolation of the overall program administrator from access as well. Aides will have family emails to communicate if the account is closed and further the aide will have an email account for the overall program use.

As a further security provision, the data matrix may be constructed as a puzzle, as shown in FIG. 8. Access would be based on the assigned aide, who has one piece of the puzzle 260a, and the client that has the other piece of the puzzle 260b, joining the two pieces referencing mechanical keys 262 to provide the complete data matrix 264 that opens the folder with links to open accounts. The owner of the accounts is the person who pays for the service and who sets the passwords. The first data code is based on the aide who is assigned to the client with whom a database linkage is required. During this service time period, and for the time after leaving the client, the aide could misuse the accounts so the family should agree to monitor use of the gallery, drop box, and emails, and also why the legal ramifications of misuse of elders is impressed upon the employee. Additional or alternate security steps could include having the aide use the data matrix code to open and activate a coupon to pay for it and then to close the folder, record both as a picture in the client's album (where it would have a time stamp), and would be sent to drop box so the family can monitor the activity. Alternately, the activation of the coupon could generate a data entry into the program/family database so the program knows to pay the aide and the family knows when the visit took place. Administrative privileges allow the family to reset passwords so the family owns the email account and the drop box account and not the overall program entity.

Although the present invention has been described in conjunction with a number of preferred embodiments, those skilled in the art will recognize that certain modifications to these systems and methods may be made without deviation from the spirit and scope of the present invention. As indicated above, although the healthcare industry and the communication of data therein provides the best example of the beneficial uses of the systems and methods of the present invention, other environments not associated with the healthcare industry may likewise benefit from the template registration process and the overall security constructs associated with isolating a particular device to a particular individual. In addition, various types of data have been described herein, most of which relates to personal healthcare information or financial information. Other types of information might likewise be subject to the privacy concerns that are described herein (such as legal information) that would again benefit from being maintained and only communicated within the constraints of the secure system described. Those skilled in the art will recognize that modifications to the systems and methods that are described above that are specific to a particular field of use will not necessarily depart from the spirit and scope of the invention.

I claim:

1. A method for allowing basic communication, such as through personal email and application accounts, as well as assisted use of the technologies, and with HIPAA compliance, allowing for the sharing of such communications, the method comprising the steps of:
carrying out an initial system registration process, the registration process comprising the steps of:
authorizing a primary care physician as the central repository of healthcare information that is subject to the privacy and security concerns of the system;
verifying an administrator for the system, the administrator being a patient (client), a primary personal caregiver, or a combination of the two;
the administrator reviewing templates that are associated with access rights authority and security associated with the system, various participants within the system categorized according to established templates that in part define their functional relationship with the patient, and in part define the type of information that they provide to the system, or require from the system;
assigning individual participants various pre-configured templates based upon the catalog of templates established for the system;
registering the assigned templates;
the administrator reviewing the various information source streams and identifying and selecting the relevant care sources;
the administrator testing access to both the care sources and to the participants through the registered templates and confirming the complete registration process; and
the administrator and/or the participants reviewing the various access pages to complete the registration process; and
carrying out a system access process for both the system patient and the system participants by recognizing the assigned and registered templates for each participant attempting access and allowing access to communications paths within the system based only on such permissions accorded each participant by the assigned and registered templates.
